(19) United States
(12) Patent Application Publication
(10) Pub. No.: US 2025/0262961 A1
(43) Pub. Date: Aug. 21, 2025

(54) CHARGER

(71) Applicant: LG ELECTRONICS INC., Seoul (KR)

(72) Inventors: Kangsuk LEE, Seoul (KR); Hoon HUR, Seoul (KR)

(73) Assignee: LG ELECTRONICS INC., Seoul (KR)

(21) Appl. No.: 19/099,517

(22) PCT Filed: Aug. 22, 2023
(86) PCT No.: PCT/KR2023/012440

§ 371 Date: Jan. 29, 2025

(51) Int. Cl. B60L 53/18; B60L 53/31

(52) U.S. Cl. CPC B60L 53/18; B60L 53/31

(57) ABSTRACT

A charger may comprise a rail body having a plurality of rails formed thereon; a plurality of guides disposed to slide on each of the plurality of rails and on which a charging cable is mounted; and a spacer spaced apart from the plurality of guides. The spacer may comprise a plurality of spacer guides configured to guide different portions of the charging cable; and a bridge connecting the plurality of spacer guides.

### TECHNICAL FIELD

The present disclosure relates to a charger.

### BACKGROUND ART

A charger is a device used to charge storage batteries.

An example of a charger may be an electric vehicle charger that charges vehicles such as electric vehicles, and electrical energy is supplied to the battery of the electric vehicle by connecting the charging connector provided at the end portion of the charging cable to the connection inlet installed in the electric vehicle.

To use the charging cable, the coiled charging cable is unwound and pulled out before use, but, the pulled charging cable may touch the floor in part due to the length thereof, and the part touching the floor may be damaged, such as by wear and tear from repeated use, and may be contaminated by contaminants on the floor.

An example of a charger is a charging device for an electric vehicle disclosed in Korean Patent Publication No. 10-2021-0026907A (published on Mar. 10, 2021), which comprises: a charging main body; a charging cable connected to the charging main body and having a charging gun provided at an end portion thereof; a guide frame installed on one side of the charging main body and having a rail guide formed thereon; first and second roller devices formed to be able to travel along the rail guide of the guide frame; and a mounting bracket connected to the first and second roller devices and transported together, and on which the charging cable is mounted; wherein the first and second roller devices are capable of traveling on the rail guide according to the stop position of the electric vehicle requiring charging, thereby moving the position of the charging cable.

Another example of a charger is a charging facility for an electric vehicle disclosed in Korean Patent Publication No. 10-2019-0091673A (published on Aug. 7, 2019), in which the charging facility for an electric vehicle comprises: a cable guide part installed on the ceiling of a car deck on which an electric vehicle is loaded; a vehicle charging device that charges a driving battery of the electric vehicle while moving along the cable guide part in the front and rear direction; and a power management device that supplies power to the driving battery, in which the cable guide part comprises a rail that provides a path along which the driving part of the vehicle charging device moves and is installed on the ceiling in the longitudinal direction of the car deck on which the electric vehicles are disposed in a straight line; and a guide ring that is installed in multiple numbers so as to be able to slide along the rail and is configured so that a charging cable of the vehicle charging device may be hung at a predetermined interval, in which the vehicle charging device comprises: a charging cable having one end portion connected to the power management device and the other end portion provided with a plug to charge the driving battery; and a driving part that is installed so as to be drivable on the cable guide part and moves the charging cable.

### DISCLOSURE

### Technical Problem

An object of the present embodiment is to provide a charger capable of minimizing tangling of a charging cable.

### Technical Solution

A charger according to the present embodiment may comprise a rail body having a plurality of rails formed thereon; a plurality of guides disposed to slide on each of the plurality of rails and on which a charging cable is mounted; and a spacer spaced apart from the plurality of guide.

The spacer may comprise a plurality of spacer guides configured to guide different portions of the charging cable; and a bridge connecting the plurality of spacer guides.

The plurality of spacer guides may comprise a lower spacer guide configured to guide a lower end portion of the charging cable; and an upper spacer guide configured to guide a portion between the lower end portion of the charging cable and a mounting portion mounted on the guide.

A pair of upper spacer guides may be provided.

The bridge may comprise a first bridge connected to the pair of upper spacer guides and configured to separate the pair of upper spacer guides; and a second bridge connected to the first bridge and the lower spacer guide and configured to separate the first bridge and the lower spacer guide.

Each of the plurality of guides may comprise a base; and a supporter formed on a lower surface of the base and on which the charging cable is mounted.

Each of the plurality of guides may comprise an overlapping area configured to overlap with an adjacent other guide in the length direction of the guide to be caught, and a non-overlapping area configured not to overlap with an adjacent other guide in the length direction of the guide.

The overlapping area may be formed on the base, and the supporters of the plurality of guides may not overlap.

The supporter of each of the plurality of guides may be formed with an opening that is opened in a horizontal direction.

Opening directions of the openings of adjacent guides may be opposite to each other.

The moving direction of the guide and the opening direction of the opening may be orthogonal to each other.

The first distance between the supporters of adjacent guides in the longitudinal direction of the rail body may be longer than the second distance between the centers of the supporters of adjacent guides in a direction orthogonal to the longitudinal direction of the rail body.

The supporter may be not parallel to the side surface of the base.

The plurality of rails may be spaced apart in a direction orthogonal to the longitudinal direction of the rail body.

The rail body may comprise a body portion positioned between a pair of adjacent rails.

The body portion may gradually expand from one end to the other end of the rail body.

The charger may further comprise a main body to which the charging cable is connected.

The one end may be closer to the main body than the other end.

[Advantageous Effect]

According to the present embodiment, the shape of the charging cable may be maintained in a state where the spacer is spaced apart, and abrupt bending of the charging cable may be minimized.

In addition, each of the plurality of guides may move sequentially in the order in which the plurality of guides is disposed on the rail body, including an overlapping area and a non-overlapping area, so that tangling of the charging cable may be minimized.

In addition, since an overlapping area is formed at the base of each of the plurality of guides and the supporters of each of the plurality of guides do not overlap, tangling of the charging cable may be minimized.

In addition, since the moving direction of the guide and the opening direction of the opening are orthogonal, the moving direction of the guide and the winding direction of the charging cable may be consistent, and the user may move the charging cable by applying less force in the direction of moving the charging cable.

Additionally, since the supporter is not parallel to the side of the base, the overlap of the charging cable 3 may be minimized.

In addition, since the distance between a plurality of rail bodies gradually increases from one end to the other of the rail body, tangling of charging cables may be minimized.

### DESCRIPTION OF DRAWINGS

FIG. 1 is a perspective view illustrating a charger when a charging cable according to the present embodiment is inserted;

FIG. 2 is a perspective view illustrating a charger when the charging cable according to the present embodiment is pulled out;

FIG. 3 is a view illustrating the configuration of a main body according to the present embodiment;

FIG. 4 is a bottom view illustrating the bottom surface of the rail body according to the present embodiment;

FIG. 5 is a perspective view illustrating a guide according to the present embodiment;

FIG. 6 is a partially cut-away perspective view illustrating a rail body and guide according to the present embodiment;

FIG. 7 is a view illustrating a plurality of guides according to the present embodiment;

FIG. 8 is a bottom view illustrating when guides according to the present embodiment are disposed adjacently;

FIG. 9 is a view illustrating a spacer and a charging cable according to the present embodiment;

FIG. 10 is a perspective view illustrating the spacer guide illustrated in FIG. 9;

FIG. 11 is a bottom view illustrating another example of a guide according to the present embodiment; and

FIG. 12 is a bottom view illustrating another example of a rail body according to the present embodiment.

### BEST MODE

Hereinafter, specific embodiments of the present disclosure will be described in detail along with the drawings.

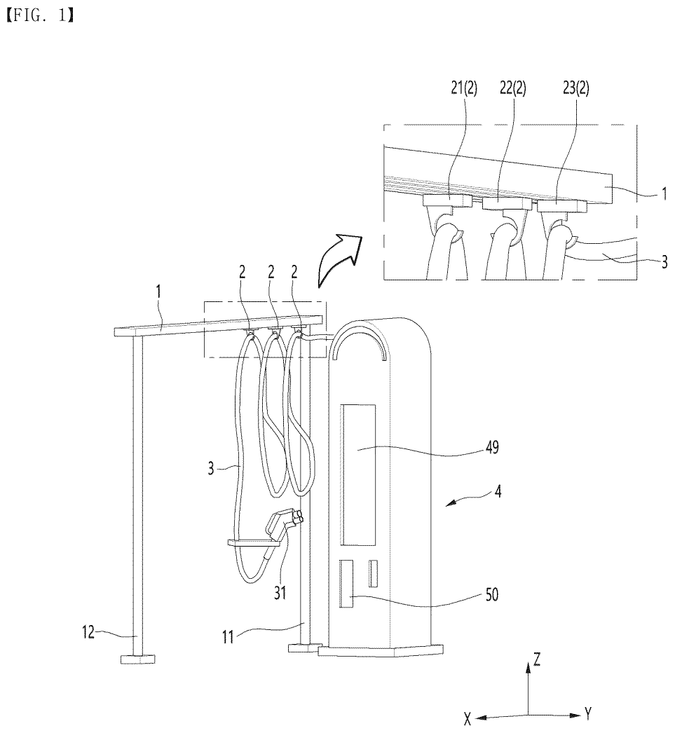

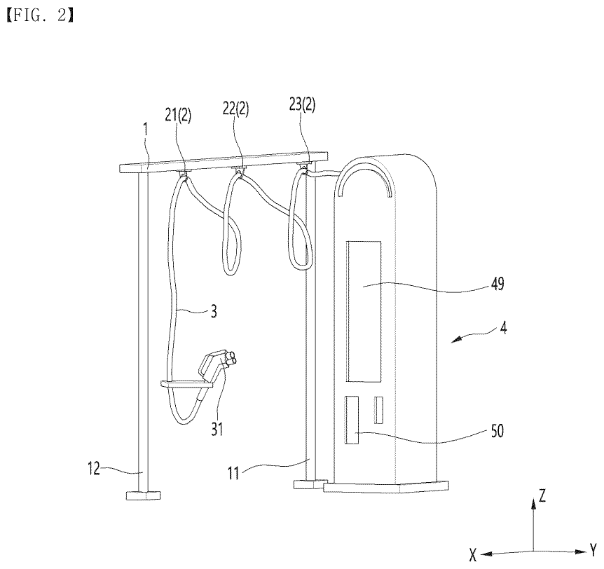

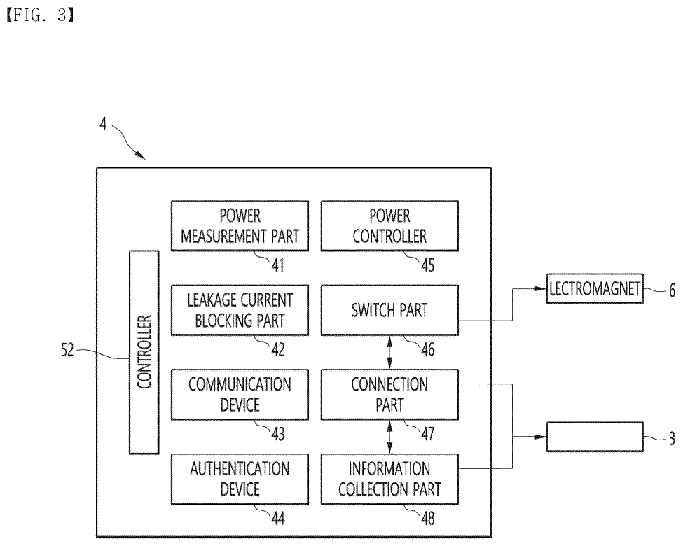

FIG. 1 is a perspective view illustrating a charger when a charging cable according to the present embodiment is inserted, FIG. 2 is a perspective view illustrating a charger when the charging cable according to the present embodiment is pulled out, and FIG. 3 is a view illustrating the configuration of a main body according to the present embodiment;

A charger may be a charging station that charges electric vehicles.

The charger may comprise a rail body 1, a plurality of guides 2, a charging cable 3, and a main body 4.

The rail body 1 may be disposed on the main body 4 or close to the main body 4.

The rail body 1 may be disposed on a pair of posts 11 and 12 spaced apart from each other. The rail body 1 may be disposed to be long in the front and rear direction X.

A rail on which a guide 2 slides may be formed in the rail body 1.

A plurality of guides 2 may slide along the rail body 1. The plurality of guides 2 may be disposed on the rail body 1 so as to slide independently of one another. The plurality of guides 2 may be spaced apart in the longitudinal direction X of the rail body 1.

Each of the plurality of guides 2 may be non-magnetic. Each of the plurality of guides 2 may be non-conductive.

A plurality of guides 2 may be disposed in a row on the rail body 1. A plurality of guides 2 may be disposed in a row in the longitudinal direction X of the rail body 1.

The charging cable 3 may be sequentially mounted on a plurality of

guides 2. The plurality of guides 2 may be disposed spaced apart from each other in the longitudinal direction X of the rail body 1.

The plurality of guides 2 may have the same configuration. The number of guides 2 may be 2, 3, 4, or the like and for the convenience of the following explanation, a case of 3 guides will be described, but, of course, the number of guides 2 is not limited. Meanwhile, when describing the common configuration of the plurality of guides 2, they are described as guides 2, and when described separately, they are described as a first guide 21, a second guide 22, and a third guides 23.

The plurality of guides 2 may distribute the load for mounting the charging cable 3, and the user may pull or push the charging cable 3 with a small force. The plurality of guides 2 may move sequentially and may be changed to various positions along the rail body 1.

As illustrated in FIG. 1, a plurality of guides 2 may be gathered as close as possible to the post 11 that is closer to the main body 4 among the pair of posts 11 and 12, and the coupler 31 of the charging cable 3 may be close to the main body 4. In this case, the charging cable 3 may be defined as being introduced.

As illustrated in FIG. 2, the plurality of guides 2 may be spaced apart from each other so that the coupler 31 of the charging cable 3 is away from the main body 4, and in this case, the charging cable 3 may be defined as being pulled out.

The charging cable 3 may be extended from the main body 4 and may be mounted on each of the plurality of guides 2. One end of the charging cable 3 may be connected to a connection part 47 (see FIG. 3) of the main body 4, and a coupler 31 may be provided at the other end of the charging cable 3. An example of the coupler 31 may be a charging gun that a user may hold.

The charger may comprise a communication device that communicates with the electric vehicle being charged by the charging cable 3. The communication device may be a PLC communication device or the like. The communication device may be provided in the coupler 31. The communication device disposed in the coupler 31 may receive information related to charging from the electric vehicle. The communication device of the coupler 31 may communicate with the controller 52.

A charging cable 3 may be connected to the main body 4.

The main body 4 may be a charger main body, and the main body 4 may comprise a housing or case that forms the outer appearance of the charger.

Referring to FIG. 3, the main body 4 may be provided with a power measurement part 41, a leakage current blocking part 42, a communication device 43, an authentication device 44, a power controller 45, a switch part 46, a connection part 47, and an information collection part 48.

The power measurement part 41 may measure the power supplied to the electric vehicle through the charging cable 3.

The leakage current blocking part 42 may comprise a circuit that blocks leakage current of the main body 4 or the charging cable 3.

The communication device 43 may comprise a device that communicates with a mobile terminal, a server, or the like.

The authentication device 44 may authenticate a user using the charger.

The power controller 45 may control the power of the main body 4 or the charging cable 3.

The switch part 46 may be electrically connected to a power supply part (not illustrated) provided to the guide 2, and the switch part 46 may cause current to be applied to or cut off from the power supply part provided to the guide 2. The switch part 46 may cause current to be applied in the opposite direction.

The switch part 46 may comprise a first switch capable of cutting off the current applied to the power supply part.

The switch part 46 may comprise a second switch capable of switching the current applied to the power supply part in the opposite direction.

The first switch and the second switch may also be disposed apart from each other on the power grid line. One of the first switch and the second switch may be disposed on the main body 4, and the other of the first switch and the second switch may be disposed on the power supply part of the guide 2.

The first switch and the second switch may be provided together in a single switch element, and it is also possible for a single switch element to apply and cut off current and change the direction of current.

A charging cable 3 may be connected to the connection part 47.

The information collection part 48 may collect and store information on the charging cable 3.

Here, the information of the charging cable 3 may comprise connection information, charging information, mounting information (or standby information), or the like of the charging cable 3.

Connection information may be information on whether the coupler 31 of the charging cable 3 is connected to or disconnected from the electric vehicle.

Charging information may comprise information such as whether the charging cable 3 is currently charging and what percentage of the electric vehicle battery is charged.

The mounting information may comprise information such as whether the coupler 31 of the charging cable 3 is mounted in the holster 50 or detached from the holster 50.

A screen 49 (see FIGS. 1 and 2) may be disposed on the main body 4.

The user may check charging information through the screen 49 and input charging commands or payment information through the screen 49.

The main body 4 may comprise a holster 50 in which a coupler 31 of a charging cable 3 is mounted. The holster 50 may be a coupler holder or a charging gun holder.

A coupler sensor 51 that senses a coupler 31 may be installed in the holster 50. Examples of the coupler sensor may be a distance sensor or a hall sensor, and may sense the presence or absence of a coupler 31. The coupler sensor 51 is not limited to its type, and any configuration capable of sensing the presence or absence of a coupler 31 may be applied.

When the coupler sensor 51 is a hall sensor, a magnet may be installed in the coupler 31, and the coupler sensor 51 may detect a magnetic field when the coupler 31 is disposed in the holster 50. The coupler sensor 51 may transmit the detection result to the controller 52. The coupler sensor 51 may transmit the mounting information to the controller 52.

When the coupler 31 is completely mounted in the holster 50, the coupler sensor 51 may transmit an on signal to the controller 52. When the coupler 31 is separated from the holster 50, the coupler sensor 51 may transmit an off signal to the controller 52.

The charger may further comprise a controller 52 that controls the overall operation of the charger. The controller 52 may be installed in the main body 4. An example of the controller 52 may comprise a processor or microcomputer that controls the overall operation of the charger.

An outlet (not illustrated) may be formed on one side of the main body 4 through which the charging cable 3 extends outside the main body 4.

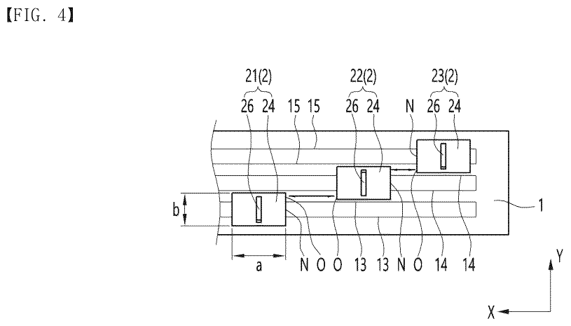

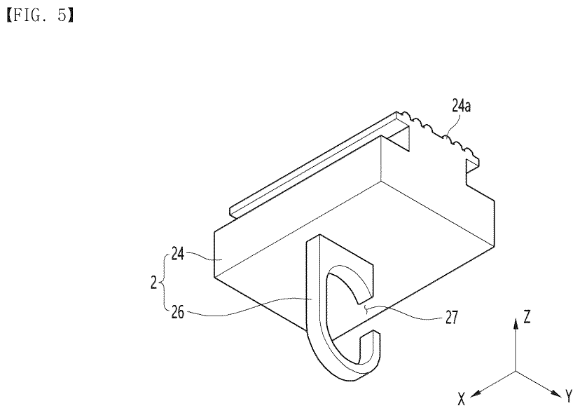

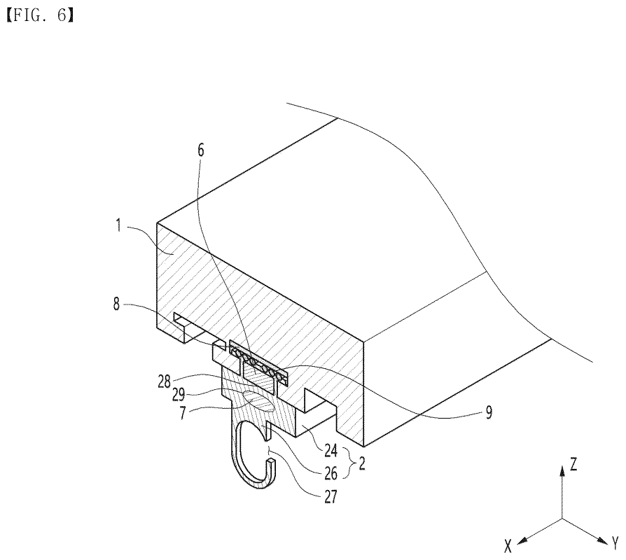

FIG. 4 is a bottom view illustrating the bottom surface of the rail body according to the present embodiment, FIG. 5 is a perspective view illustrating a guide according to the present embodiment, and FIG. 6 is a partially cut-away perspective view illustrating a rail body and guide according to the present embodiment;

The rail body 1 may comprise a beam having a space formed inside, and an opening for forming a rail may be formed in the lower plate of the beam.

The upper part of the guide 2 may be movably accommodated in the space of the beam.

The opening of the beam may be located at the lower side of the space of the beam, and the guide 2 may be moved in the longitudinal direction of the rail body 1 along the opening.

A plurality of rails 13, 14, and 15 may be formed on a rail body 1. Each of the plurality of rails 13, 14, and 15 may be formed to be long in the longitudinal direction X of the rail body 1. The plurality of rails 13, 14, and 15 may be spaced apart from each other in a direction Y orthogonal to the longitudinal direction X of the rail body 1.

A plurality of guides 2 may be disposed to slide on each of a plurality of rails 13, 14, and 15.

A plurality of rails 13, 14, and 15 may correspond 1:1 with a plurality of guides 2, and when the charger comprises a first guide 21, a second guide 22, and a third guide 23, the plurality of rails 13, 14, and 15 may comprise a first rail 13 on which the first guide 21 is slidably guided, a second rail 14 on which the second guide 22 is slidably guided, and a third rail 15 on which the third guide 23 is slidably guided.

The upper plate of each of the plurality of guides 2 may be disposed on a rail

Each plane of the plurality of guides 2 may be rectangular, and the length

a may be greater than the width b.

Each of the plurality of guides 2 may comprise an overlapping area O and a non-overlapping area N.

The overlap area O may be an area that overlaps another adjacent guide 2 in the longitudinal direction X of the guide 2, as illustrated in FIG. 6. The overlap area O may be caught in the longitudinal direction X of the guide 2 in another adjacent guide.

The overlapping area O of the first guide 21 overlaps the second guide 22 in the longitudinal direction X of the first guide 21 and may be caught in the longitudinal direction X of the first guide 21.

The overlapping area O of the second guide 22 overlaps the third guide 23 in the longitudinal direction X of the second guide 22 and may be caught in the longitudinal direction X of the second guide 22.

The non-overlapping area N may be an area that does not overlap with another adjacent guide in the longitudinal direction X of the guide, as illustrated in FIG. 6.

The non-overlap area N of the first guide 21 may not extend over the second guide 22 in the longitudinal direction X of the first guide 21.

The overlap area N of the second guide 22 may not overlap the third guide 23 in the longitudinal direction X of the second guide 22.

The first guide 21 may comprise a non-overlapping area N and an overlapping area O.

The second guide 23 may comprise a pair of overlapping areas O and a non-overlapping area N located between the pair of overlapping areas O. One of the pair of overlapping areas O may overlap with the overlapping area O of the first guide 21, and the other of the pair of overlapping areas O may overlap with the overlapping area O of the third guide 23.

The third guide 23 may comprise an overlapping area O and a non-overlapping area N.

When each of the plurality of guides 2 comprises an overlapping area O and a non-overlapping area N, the plurality of guides 2 may move sequentially in the order in which they are disposed on the rail body 1, and tangling of the charging cable 3 may be minimized.

The guide 2 may comprise a base 24 and a supporter 26.

The base 24 may be guided in the longitudinal direction X of the rail body 2 along the rail body 2, and the guide 2 may be a linear moving guide.

When the charging cable 3 is mounted on the supporter 26, the supporter 26 may support the mounted part of the charging cable 3.

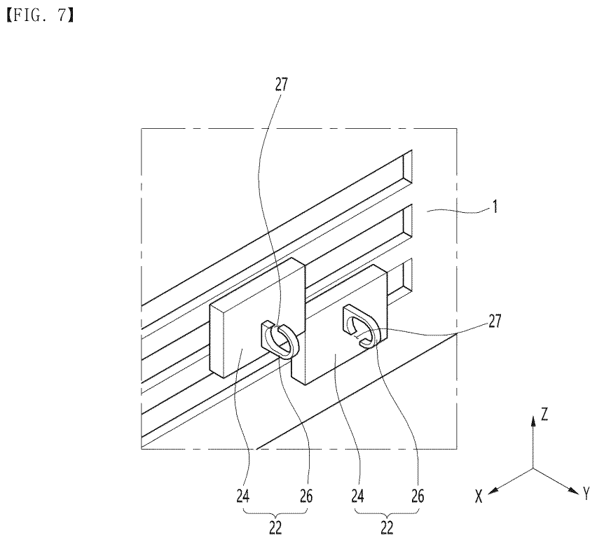

The supporter 26 may protrude downward from the lower surface of the base 24. The supporter 26 may have a ring shape, as illustrated in FIG. 7. The supporter 26 may have an opening 27 formed therein through which a charging cable 3 may pass. The opening 27 may be opened horizontally on either the left or right side portion of the supporter 26. The opening 27 may be opened in the left and right direction Y on either the left or right side portion of the supporter 26. The charging cable 3 may be inserted and mounted through the opening 27 from the side of the supporter 26.

The opening direction of the opening 27 and the moving direction of the guide 2 may be orthogonal. The guide 2 may be formed so that a space for accommodating the charging cable 3 is open in the front and rear direction X and may move in the front and rear direction X. The opening 27 may be formed so as to be open in the left and right direction Y on the periphery of the supporter 26.

When the moving direction X of the guide 2 is the front and rear direction and the insertion direction Y of the charging cable 3 is the left and right direction, the moving direction of the guide 2 and the winding direction of the charging cable 2 may be consistent in the front and rear direction, and the user may move the charging cable 3 by applying less force in the direction in which the charging cable 3 moves.

The supporters 26 of the plurality of guides 2 may be parallel to each other. In this case, the overlap of the charging cables 3 mounted on the plurality of guides 2 may be minimized.

An overlapping area O may be formed in the base 24, and the supporters 26 of the plurality of guides 2 may not overlap, in which case tangling of the charging cable 3 may be minimized.

A magnet may be disposed on the rail body 1, and an electromagnet 6 (see FIG. 6) may be disposed on each of the plurality of guides 2. An electromagnet accommodation part 28 in which an electromagnet 6 is accommodated may be formed inside the guide 2. The electromagnet 6 may be electrically connected to a power supply part.

When the electromagnets 6 disposed in the plurality of guides 2 are controlled with the same polarity, the plurality of guides 2 may move away from each other due to the repulsive action of the electromagnets 6, and when the electromagnets disposed in the plurality of guides 2 are controlled with the opposite same polarity, the plurality of guides 2 may move closer to each other due to the attractive action of the electromagnets 6.

When the electromagnet 6 is turned on, it can be locked to the magnet by the attractive force between the magnet and the electromagnet.

The charger may comprise a guide communication device 7 disposed in a guide 2. A communication device accommodation part 29 in which the guide communication device 7 is accommodated may be formed inside the guide 2.

Examples of communication devices 7 may comprise a BT communication device, a UWB communication device, or the like.

Users or administrators may communicate with the guide communication device 7 through a mobile terminal or the like outside the charger, and the guide communication device 7 may receive signals from the mobile terminal or the like.

The guide communication device 7 may communicate with the communication device equipped in the coupler 31, and the electromagnet 6 equipped in the guide 2 may be turned on or off according to a command received by the guide communication device 7.

The charger may further comprise a flat cable 8. The flat cable 8 may be a power supply part that supplies power to the electromagnet 6. The flat cable 8 may be disposed to be long in the longitudinal direction X of the rail body 1. The flat cable 8 may be in a band shape or a plate shape. The flat cable 8 may be accommodated in the space of the beam.

A flat cable 8 may be disposed between the rail body 1 and the guide 2. The flat cable 8 may be disposed on the upper side of the upper surface of the guide 2. The flat cable 8 may be extended long in the horizontal direction, particularly in the front and rear direction.

The flat cable 8 may apply the current to the electromagnet 6 of the guide 2 while the flat cable is fixed in position on the rail body 1.

The charger may further comprise a ball 9.

The ball 9 may be disposed on the upper surface of the guide 2.

A ball accommodation part 24a that accommodates a portion of a ball 9 may be formed on the upper surface of the guide 2. The ball 9 may roll when the guide 2 moves.

A plurality of balls 9 may be disposed in the charger, and the guide 2 may slide smoothly on the rail body 1.

FIG. 7 is a view illustrating a plurality of guides according to the present embodiment.

The opening directions of the openings 27 of the supports 26 of the plurality of guides 2 may be alternately opposite to each other.

In other words, each of the supporters 26 of the plurality of guides 21, 22, and 23 has an opening 27 that is opened in a horizontal direction, and the opening directions of the openings (27) of adjacent guides may be opposite to each other.

When the opening 27 formed in the supporter 26 of the first guide 21 is formed on the left side portion of the supporter 26, the opening 27 formed in the supporter 26 of the second guide 22 may be formed on the right side portion of the supporter 26, and the opening 27 formed in the supporter 26 of the third guide 23 may be formed on the left side portion of the supporter 26.

Conversely, when the opening 27 formed in the supporter 26 of the first guide 21 is formed on the right side portion of the supporter 26, the opening 27 formed in the supporter 26 of the second guide 22 may be formed on the left side portion of the supporter 26, and the opening 27 formed in the supporter 26 of the third guide 23 may be formed on the right side portion of the supporter 26.

When the opening 27 formed in the supporter 26 of the adjacent guide is opened in the opposite direction, the charging cable 3 may be reliably mounted in a plurality of guides 2.

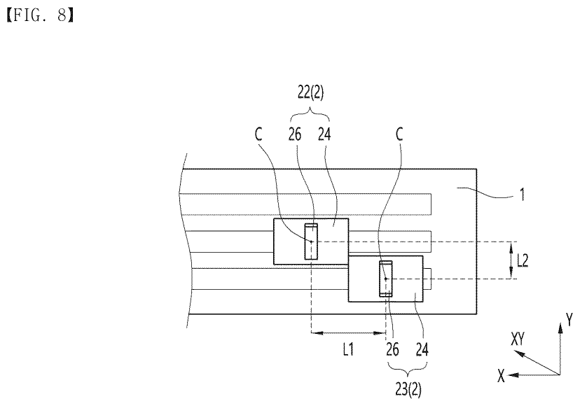

FIG. 8 is a bottom view illustrating when guides according to the present embodiment are disposed adjacently.

The supporters 26 of adjacent guides 22 and 23 may be spaced apart in the oblique direction XY between the front and rear direction and the left and right direction.

The first distance L1 between the supporters 26 of adjacent guides 22 and 23 may be longer than the second distance L2 between the centers C of the supporters 26 of adjacent guides 22 and 23.

The first distance L1 may be a distance in the front and rear direction and may be a distance in the longitudinal direction X of the rail body 1.

The second distance L2 may be a distance in the left and right direction and may be a distance in the direction Y orthogonal to the longitudinal direction X of the rail body 1.

When the first distance L1 is longer than the second distance L2, the radius of curvature of the curved portion of the charging cable 3 may be increased, and the longitudinal bending of the charging cable 3 may be minimized.

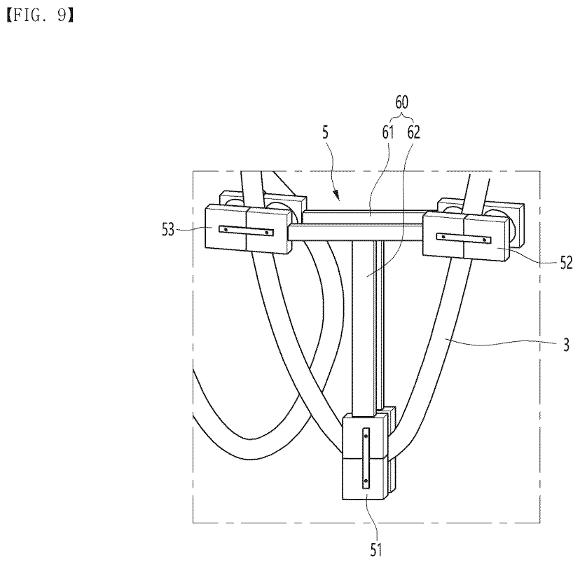

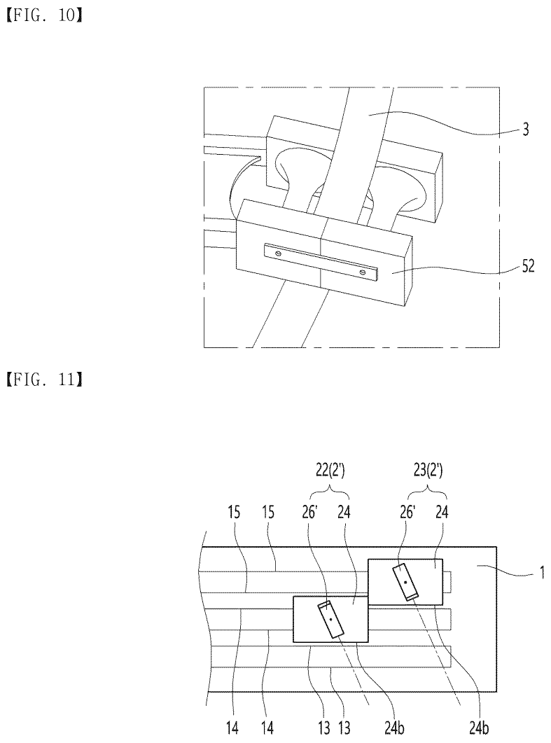

FIG. 8 is a view illustrating a spacer and a charging cable according to the present embodiment, and FIG. 9 is a perspective view illustrating the spacer guide illustrated in FIG. 8.

The charger may comprise a spacer 5 spaced apart from the plurality of guides 2.

When a charger cable 3 is mounted on the plurality of guides 2, the charging cable 3 may be divided into a mounting portion that is in contact with the guide 2 and is mounted on the guide 2, and a non-contact portion that extends from the mounting portion and is not in contact with the guide 2 and connects adjacent mounting portions.

The non-contact portion may be roughly U-shaped or V-shaped.

The spacer 5 may maintain the charging cable 3 in the shape that does not cause the non-contact portion to bend sharply.

When the lower part of the non-contact portion is pulled downward, the non-contact portion may have an approximate V shape, and the spacer 5 may guide the non-contact portion so that the non-contact portion is not bent as much as possible and has a U shape or a shape close to a U shape.

The spacer 5 may comprise a plurality of spacer guides 51, 52, and 53 and a bridge 60.

The plurality of spacer guides 51, 52, and 53 may comprise a lower spacer guide 51 and an upper spacer guide

The lower spacer guide 51 may guide the lower end portion of the charging cable 3 among non-contact portions.

The upper spacer guide may guide the portion between the lower end portion of the charging cable 2 and the mounting portion mounted on the guide 2.

A pair of upper spacer guides may be provided. The pair of upper spacer guides 52 and 53 may be spaced apart in the horizontal direction.

The bridge 60 may connect the plurality of spacer guides 51, 52, and 53.

The bridge 60 may be in a ‘T’ shape.

The bridge 60 may comprise a first bridge 61 and a second bridge 62.

The first bridge 61 may be connected to a pair of upper spacer guides 52 and 53 and may separate the pair of upper spacer guides 52 and 53.

The first bridge 61 may horizontally separate the pair of upper spacer guides 52 and 53.

The second bridge 62 may be connected to the first bridge 61 and the lower spacer guide 51 and may separate the first bridge 62 and the lower spacer guide 51.

The second bridge 62 may separate the first bridge 62 and the lower spacer guide 51 in the vertical direction Z.

FIG. 11 is a bottom view illustrating another example of a guide according to the present embodiment.

Another example of a guide 2′ may comprise a base 24 and a supporter 26′.

The supporter 26′ may not be parallel to the side surface 24b of the base 24, as illustrated in FIG. 11. The supporter 26′ may not be orthogonal to the side surface 24b of the base 24.

The supporter 26′ may be formed to be inclined to the base 24. The supporter 26′ may be formed to be long in an inclined direction between the left and right direction and the front and rear direction.

If the supporter 26′ may be formed at an angle to the base 24, the overlap of the charging cable 3 may be minimized.

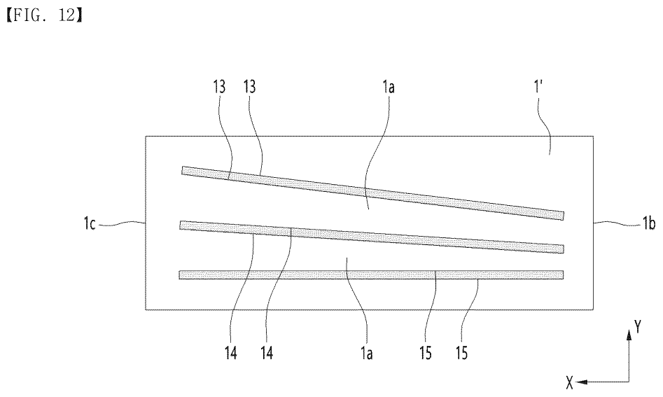

FIG. 12 is a bottom view illustrating another example of a rail body according to the present embodiment.

The plurality of rails 13, 14, and 15 illustrated in FIG. 12 may be spaced apart in a direction Y orthogonal to the longitudinal direction X of the rail body 1′, and the rail body 1′ may comprise a body portion 1a positioned between a pair of adjacent rails, and the body portion 1a may gradually expand from one end 1b to the other end 1c of the rail body 1′.

One end 1b may be closer to the main body 4 (see FIGS. 1 and 2) than the other end 1c.

The rail body 1′ illustrated in FIG. 12 may have angles of some of the plurality of rails 13, 14, and 15 that are different from the plurality of rails 13, 14, and 15 of the rail body 1 illustrated in FIG. 4.

Some 13 of the plurality of rails 13, 14, and 15 may be long in the longitudinal direction X of the rail body 1, and the remaining 14 and 15 of the plurality of rails 13, 14, and 15 may be formed to be long in an inclined direction inclined at a predetermined angle with respect to the longitudinal direction X of the rail body 1.

A plurality of rails 13, 14, and 15 may be spaced apart in a direction Y orthogonal to the longitudinal direction X of the rail body 1, and the distance between the plurality of rails 13, 14, and 15 may gradually increase from one end 1b to the other end 1c, and tangling of the charging cable 3 may be minimized.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but are for illustrative purposes, and the scope of the technical idea of the present disclosure is not limited by these embodiments.

The scope of protection of the present disclosure should be interpreted in accordance with the claims below, and all technical ideas within the equivalent scope should be interpreted as being comprised in the scope of rights of the present disclosure.

1. A charger comprising:
a rail body having a plurality of rails formed thereon;
a plurality of guides disposed to slide on each of the plurality of rails and on which a charging cable is mounted; and
a spacer spaced apart from the plurality of guides, wherein the spacer comprises:
a plurality of spacer guides configured to guide different portions of the charging cable; and
a bridge connecting the plurality of spacer guides.

2. The charger of claim 1,
wherein the plurality of spacer guides comprises:
a lower spacer guide configured to guide a lower end portion of the charging cable; and
an upper spacer guide configured to guide a portion between the lower end portion of the charging cable and a mounting portion mounted on the guide.

3. The charger of claim 2,
wherein a pair of upper spacer guides are provided.

4. The charger of claim 3,
wherein the bridge comprises a first bridge connected to the pair of upper spacer guides and configured to separate the pair of upper spacer guides; and
a second bridge connected to the first bridge and the lower spacer guide and configured to separate the first bridge and the lower spacer guide.

5. The charger of claim 1,
wherein each of the plurality of guides comprises:
a base; and
a supporter formed on a lower surface of the base and on which the charging cable is mounted.

6. The charger of claim 5,
wherein each of the plurality of guides comprises:
an overlapping area configured to overlap with an adjacent other guide in the length direction of the guide to be caught, and
a non-overlapping area configured not to overlap with an adjacent other guide in the length direction of the guide.

7. The charger of claim 6,
wherein the overlapping area is formed on the base, and
wherein the supporters of the plurality of guides do not overlap.

8. The charger of claim 5,
wherein the supporter of each of the plurality of guides is formed with an opening that is opened in a horizontal direction, and
wherein opening directions of the openings of adjacent guides are opposite to each other.

9. The charger of claim 5,
wherein the supporter of each of the plurality of guides is formed with an opening that is opened in a horizontal direction, and
wherein a moving direction of the guide and an opening direction of the opening are orthogonal to each other.

10. The charger of claim 5,
wherein a first distance between the supporters of adjacent guides in the longitudinal direction of the rail body is longer than a second distance between the centers of the supporters of adjacent guides in a direction orthogonal to the longitudinal direction of the rail body.

11. The charger of claim 5,
wherein the supporter is not parallel to a side surface of the base.

12. The charger of claim 1,
wherein the plurality of rails is spaced apart in a direction orthogonal to the longitudinal direction of the rail body,
wherein the rail body comprises a body portion positioned between a pair of adjacent rails, and
wherein the body portion gradually expands from one end to the other end of the rail body.

13. The charger of claim 12, further comprising:
a main body to which the charging cable is connected,
wherein the one end is closer to the main body than the other end.
